(19) United States
(12) Patent Application Publication
(10) Pub. No.: US 2019/0033075 A1
(43) Pub. Date: Jan. 31, 2019

(54) GYROSCOPE DEVICES AND METHODS FOR FABRICATING GYROSCOPE DEVICES

(71) Applicant: Agency for Science, Technology and Research, Singapore (SG)

(72) Inventors: Guoqiang Wu, Singapore (SG); Sanchitha Nirodha Fernando, Singapore (SG); Alex Yuandong Gu, Singapore (SG); Geng Li Chua, Singapore (SG)

(21) Appl. No.: 16/073,165

(22) PCT Filed: Jan. 24, 2017
(86) PCT No.: PCT/SG2017/050036

§ 371 Date: Jul. 26, 2018

(30) Foreign Application Priority Data
Feb. 1, 2016 (SG) 10201600758W

(51) Int. Cl. G01C 19/5762

(52) U.S. Cl. CPC G01C 19/5762

(57) ABSTRACT

According to various embodiments, there is provided a gyroscope device including: an outer frame; and four cells arranged within the outer frame, each cell of the four cells including: a proof mass arranged at least substantially in a centre region of the cell; and four electrode frames, each electrode frame of the four electrode frames arranged at a corner region of the cell and coupled to a respective side of the proof mass.

### CROSS-REFERENCE TO RELATED APPLICATIONS

This application claims the benefit of Singapore Patent Application number 10201600758W filed 1 Feb. 2016, the entire contents of which are incorporated herein by reference for all purposes.

### TECHNICAL FIELD

Various embodiments relate to gyroscope devices and methods for fabricating gyroscope devices.

### BACKGROUND

There is a growing market for microelectromechanical systems (MEMS) inertial sensors, such as the micromachined Coriolis gyroscope. The MEMS Coriolis gyroscope may be preferred over optic gyroscopes and ring laser gyroscopes, due to its small size, promising performance and low cost of fabrication. Two important factors that influence the performance of the Coriolis gyroscope are sensitivity and anti-vibration capability. The sensitivity of the gyroscope may be improved, by minimizing the energy dissipation of the gyroscope. Energy dissipation through air damping may be avoided by having the gyroscope vibrate in a vacuum. Thermal elastic damping may not be a dominant energy dissipation mechanism, since most vibrating gyroscopes operate at very low frequencies, for example, at less than 50 kHz. The dominant energy loss mechanism for the gyroscope may be anchor loss, in other words, energy loss through anchors of the vibrating components of the gyroscope. Mechanical vibrations in gyroscopes may create short term output errors and degrade the gyroscope's performance. Such output errors have been observed in many devices and the errors are often categorized as either false output or sensitivity change. In a gyroscope, the measure of the angular rate must not be corrupted by linear acceleration, vibration or shock. A high rejection of environmental noise may be essential for the reliable operation of the gyroscope.

### SUMMARY

According to various embodiments, there may be provided a gyroscope device including: an outer frame; and four cells arranged within the outer frame, each cell of the four cells including: a proof mass arranged at least substantially in a centre region of the cell; and four electrode frames, each electrode frame of the four electrode frames arranged at a corner region of the cell and coupled to a respective side of the proof mass.

According to various embodiments, there may be provided a method for fabricating a gyroscope device, the method including: forming an outer frame; providing four cells within the outer frame, wherein providing each cell of the four cells includes: providing a proof mass arranged at least substantially in a centre region of the cell; forming four electrode frames in the cell, wherein each electrode frame of the four electrode frames is arranged at a corner region of the cell, and wherein each electrode frame is coupled to a respective side of the proof mass.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1 shows a conceptual diagram illustrating the basic principles of the Coriolis Effect.

FIG. 2 shows a schematic diagram of a conventional gyroscope.

FIG. 3 shows a schematic diagram of a gyroscope device according to various embodiments.

FIG. 4A shows a structural diagram of the gyroscope device of FIG. 3.

FIG. 4B shows a structural diagram of a cell of the gyroscope device of FIG. 3.

FIG. 4C shows a structural diagram of a gyroscope device according to various embodiments.

FIG. 4D shows a diagram of a straight beam central coupling spring.

FIG. 4E shows a diagram of an overlap variation electrode.

FIG. 4F shows a diagram of a gap variation electrode

FIG. 5A shows a scanning electron microscope (SEM) image of a portion of a gyroscope device according to various embodiments.

FIG. 5B shows a SEM image of a portion of a gyroscope device according to various embodiments.

FIG. 5C shows a SEM image 500C of the straight beam central coupling spring.

FIG. 6 shows a schematic diagram of a conventional lever mechanism.

FIG. 7 shows a lever mechanism according to various embodiments.

FIG. 8A shows a simulation mode shape diagram of a gyroscope device according to various embodiments, operating in a drive mode.

FIG. 8B shows a simulation mode shape diagram of a gyroscope device according to various embodiments, operating in a sense mode.

FIGS. 9A to 9F show a method for fabricating a gyroscope device according to various embodiments.

FIG. 10 shows a conceptual diagram of a gyroscope device according to various embodiments.

FIG. 11 shows a conceptual diagram of a gyroscope device according to various embodiments.

FIG. 12 shows a flow diagram illustrating a method for fabricating a gyroscope device according to various embodiments.

FIG. 13 shows a flow diagram illustrating a method for fabricating a gyroscope device according to various embodiments.

### DESCRIPTION

Embodiments described below in context of the devices are analogously valid for the respective methods, and vice versa. Furthermore, it will be understood that the embodiments described below may be combined, for example, a part of one embodiment may be combined with a part of another embodiment.

It will be understood that any property described herein for a specific device may also hold for any device described herein. It will be understood that any property described herein for a specific method may also hold for any method described herein. Furthermore, it will be understood that for any device or method described herein, not necessarily all the components or steps described must be enclosed in the device or method, but only some (but not all) components or steps may be enclosed.

The term “coupled” (or “connected”) herein may be understood as electrically coupled or as mechanically coupled, for example attached or fixed, or just in contact without any fixation, and it will be understood that both direct coupling or indirect coupling (in other words: coupling without direct contact) may be provided.

The reference to any conventional devices in this specification is not, and should not be taken as an acknowledgement or any form of suggestion that the referenced conventional devices form part of the common general knowledge.

In order that the invention may be readily understood and put into practical effect, various embodiments will now be described by way of examples and not limitations, and with reference to the figures.

There is a growing market for microelectromechanical systems (MEMS) inertial sensors, such as the micromachined Coriolis gyroscope. The MEMS Coriolis gyroscope may be preferred over optic gyroscopes and ring laser gyroscopes, due to its small size, promising performance and low cost of fabrication. Two important factors that influence the performance of the Coriolis gyroscope are sensitivity and anti-vibration capability. The sensitivity of the gyroscope may be improved, by minimizing the energy dissipation of the gyroscope. Energy dissipation through air damping may be avoided by having the gyroscope vibrate in a vacuum. Thermal elastic damping may not be a dominant energy dissipation mechanism, since most vibrating gyroscopes operate at very low frequencies, for example, at less than 50 kHz. The dominant energy loss mechanism for the gyroscope may be anchor loss, in other words, energy loss through anchors of the vibrating components of the gyroscope. Mechanical vibrations in gyroscopes may create short term output errors and degrade the gyroscope's performance. Such output errors have been observed in many devices and the errors are often categorized as either false output or sensitivity change. In a gyroscope, the measure of the angular rate must not be corrupted by linear acceleration, vibration or shock. A high rejection of environmental noise may be essential for the reliable operation of the gyroscope.

One approach for making the gyroscope immune to vibration is to use a bulk acoustic wave (BAW) resonator as the gyroscope structure. The BAW resonator may have very high stiffness compared with a mass-spring type gyroscope. Due to its high stiffness, the BAW gyroscope may have strong inherent immunity to shock and vibration. An improvement in the vibration and acceleration rejection may also be gained through the use of a differential sensor design with two inertial masses driven out of phase, for example a tuning fork gyroscope. The differential sensor may be less sensitive to external vibration and shock, since its differential operation may cancel out common-mode noises. Nonetheless, there may be challenges in using the BAW or the differential sensor, for example limitations in anti-vibrations and accelerations rejection, low quality factor and Coriolis coupling (angle gain).

According to various embodiments, a gyroscope device may be a Coriolis gyroscope.

According to various embodiments, a gyroscope may be a MEMS gyroscope.

According to various embodiments, a gyroscope device may include a quadruple mass structure, in other words, include four masses. The gyroscope device may further include an outer frame, also referred herein as a substrate. The substrate may include four tapered levers arranged to form a square frame. The substrate may surround four individual masses, a plurality of spring elements, four central coupling springs and a plurality of electrode frames. The spring elements may couple the individual masses to the substrate, and may also couple the masses to one another. The masses may also be referred herein as proof masses. The quadruple mass structure may be symmetrical about each of the x-axis, the y-axis and diagonal axes that are 45° relative to any one of the x-axis and the y-axis. The four masses may be coupled together using four central coupling springs and four tapered levers for synchronization of anti-phase drive motions. The gyroscope device may be driven to vibrate in both the x-axis and the y-axis. The gyroscope device may also be sensed in both the x-axis and the y-axis. The x-axis may refer to a horizontal axis and the y-axis may refer to a vertical axis. Therefore, the proposed gyroscope has improved bias-stability and excellent resilience to external accelerations and vibrations along both x-axis and y-axis. Due to the ideal symmetry of the structure, the momentum and torque balance in both the driving and the sensing directions may minimize energy dissipation through the anchor, leading to high quality factor (Q) and high resolution. The gyroscope device may be immune to vibrations and accelerations in both x-axis and y-axis due to the symmetry of the structure, which may remove the input common signals. The tapered levers may be used to synchronize the anti-phase motions of the quadruple mass. The electrode frames may be triangular shaped. The electrode frame may not only allow the synchronization of the anti-phase drive motions by attaching the tapered levers to a single point, but may also restrain the spurious modes due to its structural rigidity. The gyroscope device may perform better than conventional gyroscopes, since the four tapered levers with optimized design may achieve proper synchronization for the anti-phase drive motions, which may lower the quadrature error and improve the sensitivity of the gyroscope device. The gyroscope device may be suitable for use in low-cost and high grade inertial navigation systems.

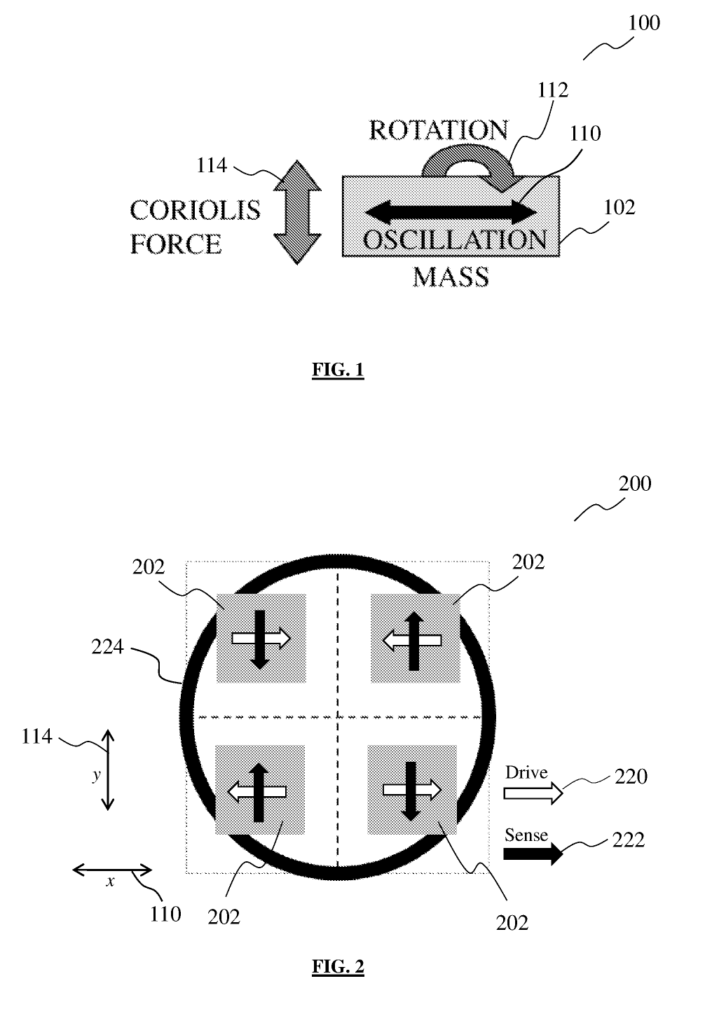

FIG. 1 shows a conceptual diagram 100 illustrating the basic principles of the Coriolis Effect. The Coriolis force is an inertial force that is experienced by an object that is moving relative to a rotation. The object may have a mass 102. The Coriolis force is proportional to the rotation rate of the mass 102 and acts in a direction perpendicular to the rotation axis. As shown in the conceptual diagram 100, a mass 102 may be oscillating along the x-axis 110. If the mass 102 is rotated in the clockwise direction 112, about a rotation axis that extends out of the plane of the paper, the mass 102 experiences a Coriolis force acting along the y-axis 114.

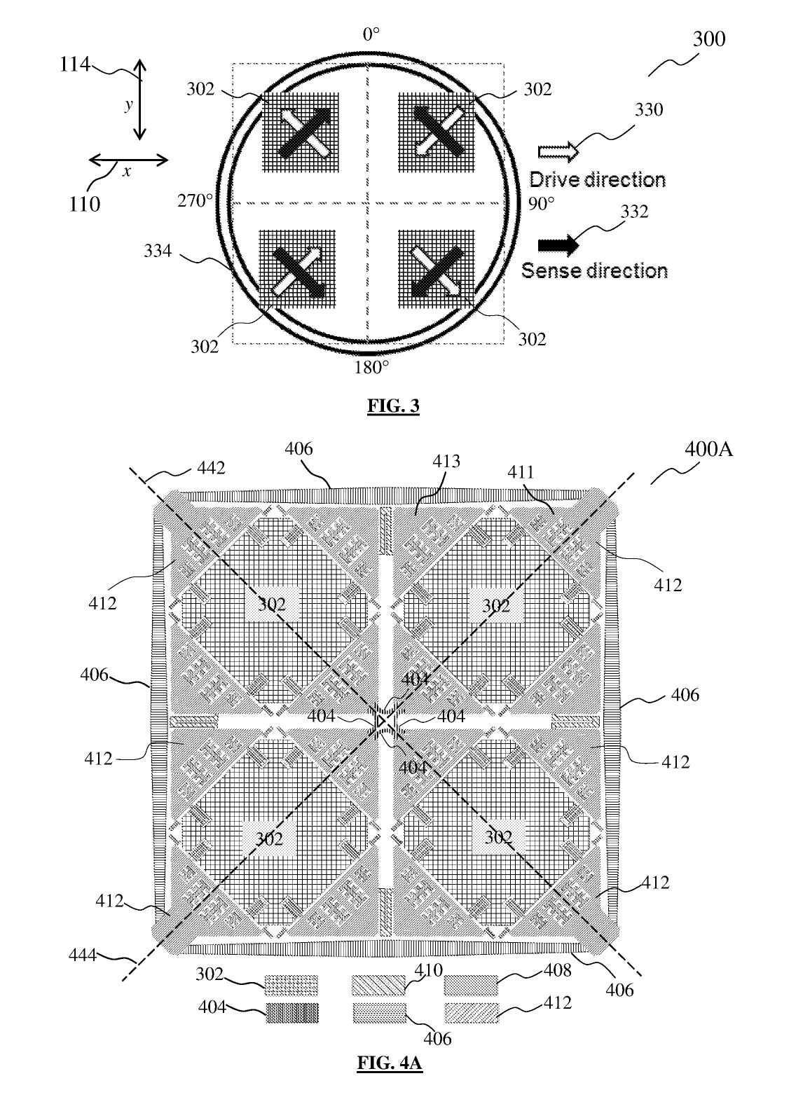

FIG. 2 shows a schematic diagram of a conventional gyroscope 200. The conventional gyroscope 200 may include four proof masses 202. Each proof mass 202 may be driven to vibrate along a first axis, and sensed along a second axis. The gyroscope 200 may be rotated in a clockwise or anticlockwise direction, the rotation indicated by a circle 224. The second axis may be perpendicular to the first axis, for example, if the proof mass 202 is driven along the x-axis 110, it may be sensed along the y-axis 114. The direction of drive is indicated in the schematic diagram by arrows 220 while the direction of sensing is indicated by arrows 222. Each proof mass 202 may be driven in an opposite direction from its adjacent proof masses 202. However, two proof masses 202 arranged diagonally may be driven in the same direction. Each proof mass 202 may be sensed in an opposite direction from its adjacent proof masses 202. Two proof masses 202 arranged diagonally may be sensed in the same direction. The gyroscope 200 may not achieve ideal symmetry in its driving and sensing of the proof masses 202. Common mode noise may not be fully cancelled out.

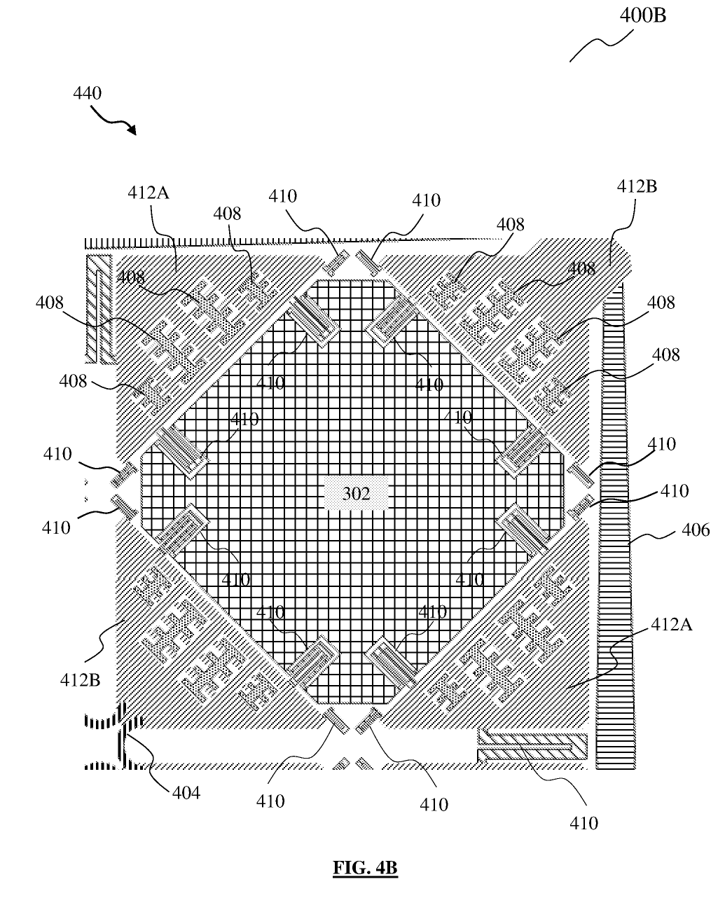

FIG. 3 shows a schematic diagram of a gyroscope device 300 according to various embodiments. The gyroscope device 300 may include four proof masses 302, i.e. may be a quadruple mass gyroscope. The four proof masses 302 may arranged in a 2 by 2 array of two rows and two columns. Each proof mass 302 may occupy one cell of the array. The proof masses 302 may be driven (in other words: excited) to vibrate diagonally with respect to the x-axis 110 and the y-axis 114. Diagonal may be understood to be at least substantially 45°. The proof masses 302 may also be sensed diagonally with respect to the x-axis 110 and the y-axis 114. The sensing direction of each proof mass 302 may be at least substantially perpendicular to the drive direction of the respective proof mass 302. The direction of drive is indicated in the schematic diagram by arrows 330 while the direction of sensing is indicated by arrows 332. The momentum and torque of the gyroscope device 300 may be balanced in both the driving and sensing directions, as the proof masses 302 are driven and sensed along both the x-axis and the y-axis.

The gyroscope 300 may be rotated in a clockwise or anticlockwise direction, the rotation indicated by a circle 334. Each proof mass 302 may be driven in a different direction from the other three proof masses 302. As an example, the top left proof mass 302 may be driven towards 315 degrees, the top right proof mass 302 may be driven towards 225 degrees, the bottom left proof mass 302 may be driven towards 45 degrees while the bottom right proof mass 302 may be driven towards 135 degrees. Similarly, each proof mass 302 may be sensed in a different direction from the other three proof masses 302. As shown in the schematic diagram as an example, the top left proof mass 302 may be sensed at 45 degrees, the top right proof mass 302 may be sensed at 315 degrees, the bottom left proof mass 302 may be sensed at 135 degrees while the bottom right proof mass 302 may be sensed at 225 degrees. The drive direction of each proof mass 302 may be reversed, in other words, changed by 180°. The sense direction of each proof mass 302 may also be reversed, depending on the direction of rotation and the drive direction of the proof mass 302. The gyroscope device 300 may achieve perfect dynamical balance between the proof masses 302, thereby suppressing substrate energy dissipation, maximizing the Q-factor of oscillations and may be immune to angular accelerations. As such, the gyroscope device 300 may achieve an improved vibration reduction capability.

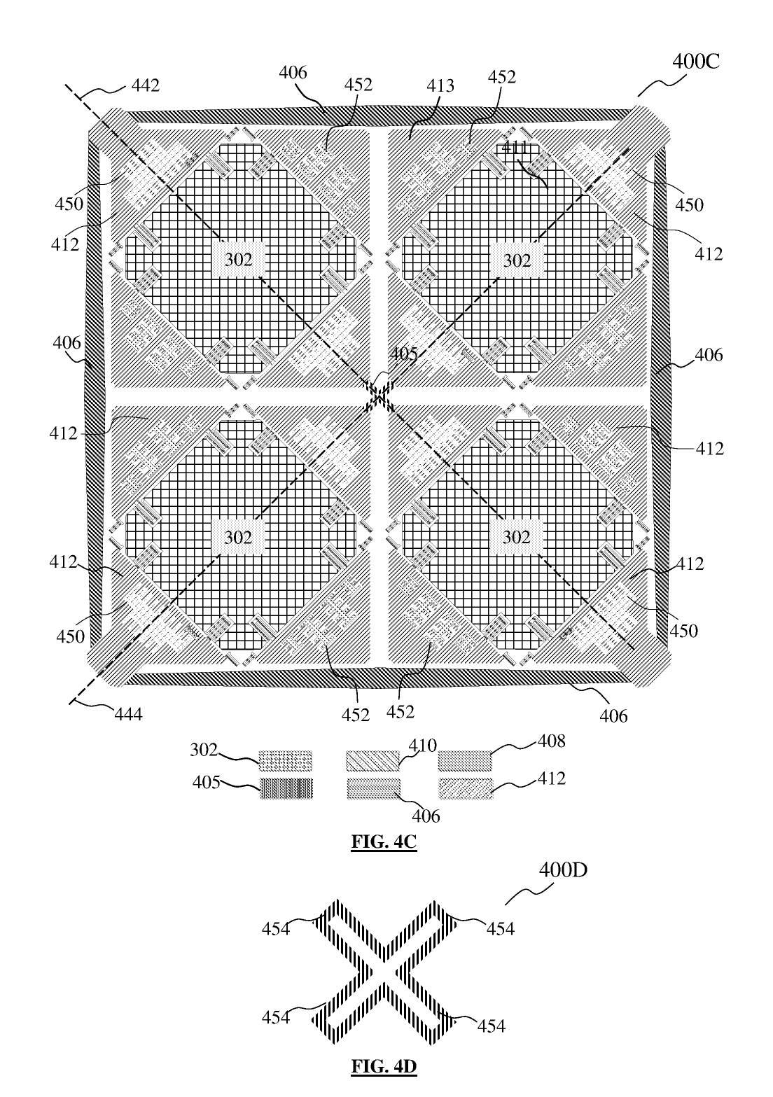

FIG. 4A shows a structural diagram 400A of the gyroscope device 300. The gyroscope device 300 may include proof masses 302, central coupling springs 404, tapered levers 406, springs 410, electrodes 408 and electrode frames 412. An electrode frame 412 may be one of a corner electrode frame 411 or an inner electrode frame 413. The gyroscope device 300 may include an outer frame and four cells arranged within the outer frame. The outer frame may include four tapered levers 406. The four tapered levers 406 may be arranged to form an at least substantially square outer frame. Each tapered lever 406 may form one side of the at least substantially square outer frame. Each tapered lever 406 may be identical in length and shape. Each tapered lever 406 may form a right angle with another tapered lever 406 at a first end through one corner electrode frame 411, and may form a right angle with another tapered lever 406 at a second end opposing the first end through another corner electrode frame 411. The corner electrode frames 411 may be positioned at the four corner regions of the gyroscope device 300. The corner electrode frames 411 may be at least substantially triangular in shape. The corner electrode frames 411 may be shaped as isosceles triangles. Each corner electrode frame 411 may have a slight protrusion at its apex. Each corner electrode frame 411 may be attached to two tapered levers 406 at the slight protrusion. The slight protrusion may also be referred herein as a coupling element. As each corner electrode frame 411 may be attached to tapered levers 406 at just a single point, the anti-phase motions of the proof masses 302 may be synchronized. In contrast, a straight or rectangular electrode frame would require the tapered levers 406 to be attached to more than one side of the electrode frame, which may result in the electrode frames twisting due to unbalanced forces from the two tapered levers 406. Furthermore, a straight frame may bend and deform, which may result in spurious modes in the operating frequency range. Triangular frames may be much more rigid, and these undesired modes may be avoided. The four cells may be arranged in a 2 by 2 array configuration. Each cell may include one proof mass 302 and four electrode frames 412. The proof mass 302 may be at least substantially square in shape. Each electrode frame 412 may be shaped at least substantially triangular. The proof mass 302 may be arranged at least substantially in a centre region of the cell, surrounded by four electrode frames 412. Each electrode frame 412 may be arranged at a corner region of the cell. One electrode frame 412 may be arranged at each side of the proof mass 302, such that the one proof mass 302 and the four electrode frames 412 collectively form an at least substantially square shape. Each electrode frame 412 may be coupled to a respective side of the proof mass 302 by a plurality of springs 410. The four proof masses 302 may be at least substantially identical in shape, size and mass. Each electrode frame 412 may be coupled to an adjacent electrode frame 412 by springs 410. Each electrode frame 412 may include at least one electrode 408. The electrode may be for example, a comb electrode. Every cell may include a first pair of electrode frames 412 and a second pair of electrode frames 412. The distance between two electrode frames 412 of the first pair of electrode frames 412 may be at least substantially perpendicular to the distance between two electrode frames 412 of the second pair of electrode frames 412. Each cell may be coupled to two adjacent cells via springs 410. A first diagonal 442 of the outer frame may be at least substantially perpendicular to a second diagonal 444 of the outer frame. The four cells may be coupled together at the centre region of the gyroscope structure or the centre region of the outer frame via central coupling springs 404. There may be four central coupling springs 404, wherein each central coupling spring 404 may be shaped at least substantially semi-circular.

A first cell in the first row of the array may be coupled to a second cell in the first row via a central coupling spring 404. The first cell in the second row of the array may similarly be coupled to a second cell in the second row via another central coupling spring 404. Further, the first cell of the first row may be coupled to the first cell of the second row via a central coupling spring 404 while the second cell of the first row may be coupled to the second cell of the second row via another central coupling spring 404. The central coupling springs 404 may prevent unwanted in-phase vibration when the proof masses 302 are driven to vibrate. The four tapered levers 406 may be used to synchronize the anti-phase drive motions. The architecture of the gyroscope device 300 may result in ultra-low energy dissipation through anchor loss. As a result, the gyroscope device 300 may achieve high quality factor for the vibrations of the proof masses 302 as well as high resolution measurements of rotations. Due to the ideal symmetry of the gyroscope device structure, the external accelerations and vibrations along both the x-axis and the y-axis may be cancelled.

FIG. 4B shows a structural diagram 400B of one quadrant, in other words, a cell 440 of the gyroscope device 300. Each cell 440 may be coupled to the outer frame or tapered levers 406 at one corner of the cell 440. Each cell 440 may include four electrode frames 412, including one corner electrode frame 411 and three inner electrode frames 413. The first pair of electrode frames 412A may be at opposing ends of the proof mass 302. The second pair of electrode frames 412B may also be at opposing ends of the proof mass 302. The distance between the two electrode frames of the first pair of electrode frames 412A may be at least substantially parallel to the first diagonal 442 while the distance between the two electrode frames of the second pair of electrode frames 412B may be at least substantially parallel to the second diagonal 444. The first pair of electrode frames 412A may include driving electrodes configured to drive the proof mass 302 and may further include sensing electrodes configured to sense movements of the proof mass 302. In other words, the electrodes 408 in the first pair of electrode frames 412A may include driving electrodes and sensing electrodes. The driving electrodes in the first pair of electrode frames 412A may be configured to drive the proof mass 302 into vibrating along the first diagonal 442. The sensing electrodes in the first pair of electrode frames 412A may be configured to sense movements of the proof mass 302 along an axis at least substantially parallel to the first diagonal 442. Similarly, the second pair of electrode frames 412B may also include driving electrodes and sensing electrodes. The driving electrodes in the second pair of electrode frames 412B may be configured to drive the proof mass 302 into vibrating along the second diagonal 444 while the sensing electrodes in the second pair of electrodes frames 412B may be configured to sense the proof mass 302 into sensing movements of the proof mass 302 along an axis at least substantially parallel to the second diagonal 444. The electrodes 408 in each electrode frame may further include a frequency tuning electrode or a quadrature-nulling electrode. The electrodes 408 may include at least one of overlap variation electrodes or gap variation electrodes.

FIG. 4C shows a structural diagram of a gyroscope device 400C according to various embodiments. The gyroscope device 400C may be similar to the gyroscope device 300, except that it may include a straight beam central coupling spring 405 in place of the four central coupling springs 404. The straight beam central coupling spring 405 may couple the four cells together at the centre region of the gyroscope device 400C. The gyroscope device 400C may include electrodes 408 arranged within the electrode frames 412. The electrodes 408 may include overlap variation electrodes 450 and gap variation electrodes 452. The drive electrodes of the gyroscope device 400C may include overlap variation electrodes 450. The sense electrodes of the gyroscope device 400C may include gap variation electrodes 452. The differences between an overlap variation electrode 450 and a gap variation electrode 452 will be further described with respect to FIGS. 4E and 4F.

FIG. 4D shows a diagram 400D of the straight beam central coupling spring 405. The straight beam central coupling spring 405 may include two straight beams arranged at least substantially perpendicularly. The two straight beams may be at least substantially identical and may intersect each other to form a cross shape. The straight beam central coupling spring 405 may include four ends 454. Each end 454 may be coupled to a respective cell in the gyroscope device 400C.

FIG. 4E shows a diagram 400E showing an overlap variation electrode 450. The overlap variation electrode 450 may include an overlap cathode 460 and an overlap anode 462. The overlap cathode 460 and the overlap anode 462 may be configured to move along a direction parallel to the arrow 470. When electric current is provided to the overlap cathode 460 and the overlap anode 462, at least one of the overlap cathode 460 or the overlap anode 462 may move along the direction parallel to the arrow 470 such that an area of overlap between the overlap cathode 460 and the overlap anode 462 changes. One of the overlap cathode 460 or the overlap anode 462 may be formed integral with the electrode frame 412 or may be anchored to the electrode frame 412 such that it may remain stationary even when it receives the electric current.

FIG. 4F shows a diagram 400F showing a gap variation electrode 452. The gap variation electrode 452 may include a gap cathode 464 and a gap anode 466. The gap cathode 464 and the gap anode 466 may be configured to move along a direction parallel to the arrow 480. When electric current is provided to the gap cathode 464 and the gap anode 466, at least one of the gap cathode 464 or the gap anode 466 may move along the direction parallel to the arrow 480 such that a gap between the gap cathode 464 and the gap anode 466 changes. One of the gap cathode 464 or the gap anode 466 may be formed integral with the electrode frame 412 or may be anchored to the electrode frame 412 such that it may remain stationary even when it receives the electric current.

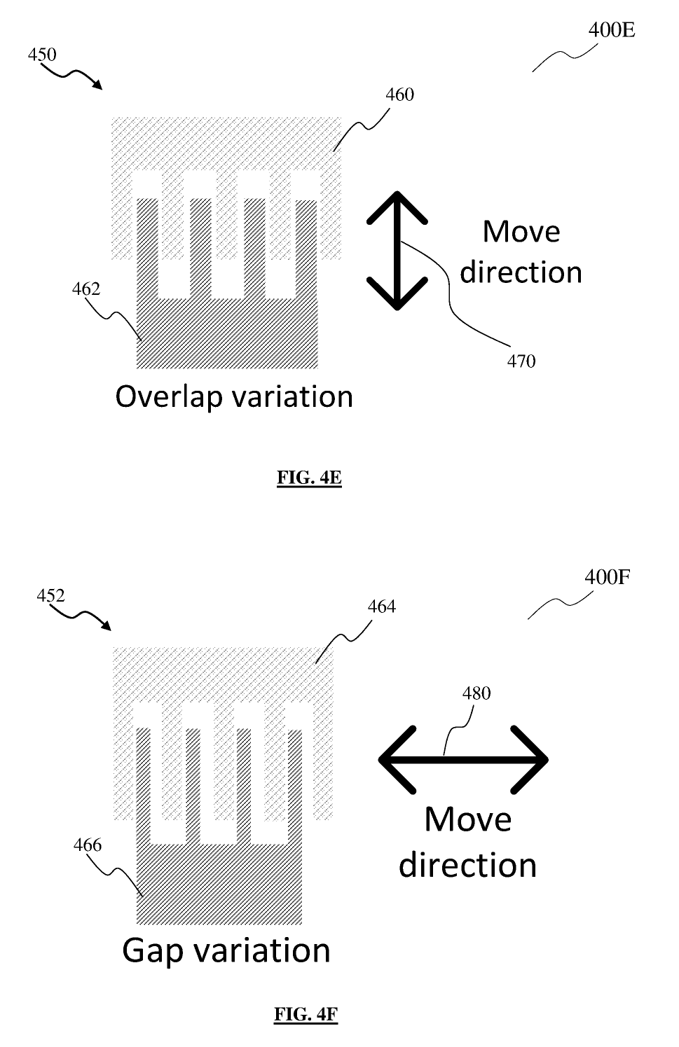

FIG. 5A shows a scanning electron microscope (SEM) image 500A of a portion of a gyroscope device according to various embodiments. The SEM image 500A shows a coupling spring 410 between two electrode frames 412, as well as the electrodes 408 of the electrode frames 412. The SEM image 500A also shows the tapered lever 406.

FIG. 5B shows a SEM image 500B of a portion of a gyroscope device according to various embodiments. The SEM image 500B shows four central coupling springs 404 in a centre of four electrode frames 412. Each central coupling spring 404 connects two electrode frames 412.

FIG. 5C shows a SEM image 500C of the straight beam central coupling spring 405 of the gyroscope device 400C. The SEM image 500C shows that the straight beam central coupling spring 405 includes four ends. Each end is coupled to an electrode frame 412 belonging to a respective cell of the gyroscope device 400C.

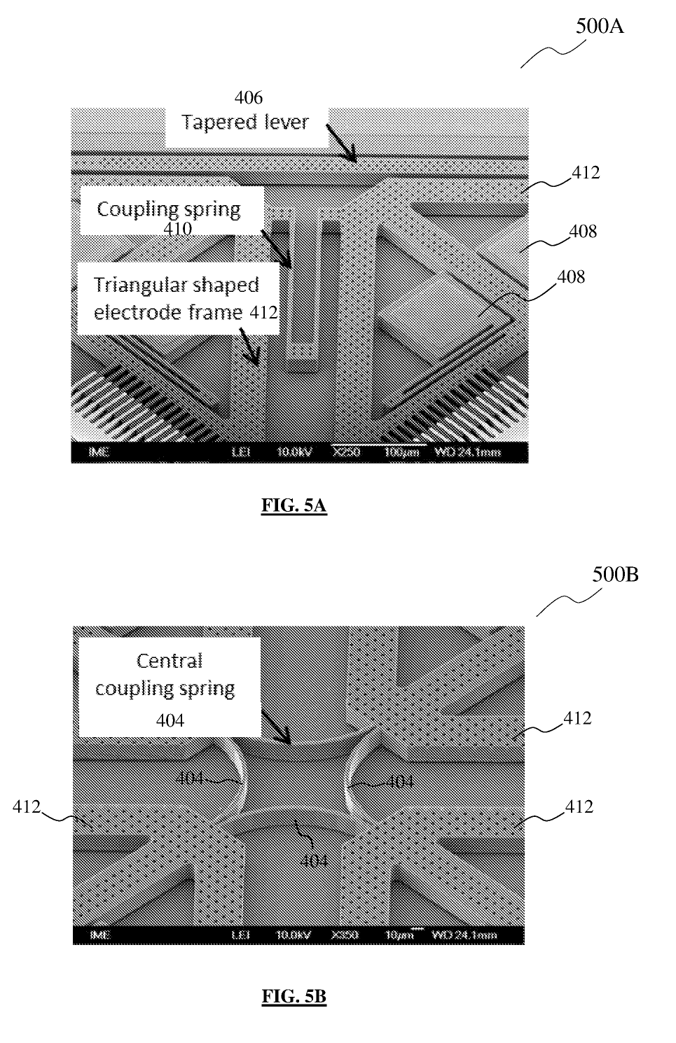

FIG. 6 shows a schematic diagram 600 of a conventional lever mechanism. A QMG may include four anti-phase lever mechanisms that synchronize the motion of the proof masses. The conventional lever mechanism may be part of the conventional gyroscope 200. The conventional lever mechanism may include a straight lever 606 and a plurality of springs 610. The springs 610 may couple the straight lever 606 to either proof masses 302 or anchors 662. The springs 610 may be coupled to both ends of the straight lever 606 and a centre of the straight lever 606. The straight lever 606 may have at least substantially parallel sides, in other words, the straight lever 606 may have an at least substantially equal width throughout its length. When a first end 666 of the straight lever 606 is moved in a direction 660A, a second end 668 of the straight lever 606 opposing the first end 666 may move in an opposing direction 660B. There may be energy loss through the anchors 662. The midsection 664 of the straight lever 606 may be fixed to the anchor 662 through springs 610. Part of the vibration energy may be dissipated through elastic wave propagation by the anchors 662, since the midsection 664 of the straight lever 606 may be a quasi-node.

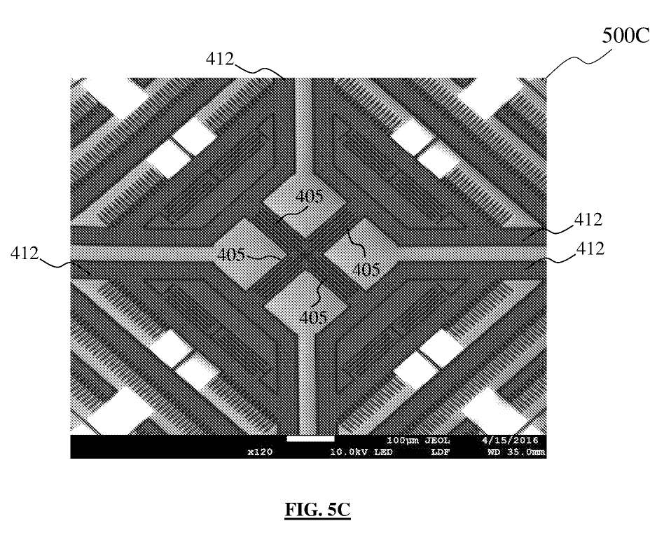

FIG. 7 shows a lever mechanism 700 according to various embodiments. The lever mechanism 700 may be part of the gyroscope device 300. The lever mechanism 700 may include the tapered lever 406. The tapered lever 406 may be a tapered beam, in other words, a beam with tapered ends. The two ends of the tapered lever 406 may be narrower in width, as compared to the midsection 774 of the tapered lever 406. The two ends are the first end 776 and the second end 778. When the first end 776 is moved in a direction 770A, the second end 778 may move in an opposing direction 770B. The midsection 774 of the tapered lever 406 may be free to move. The tapered lever 406 may bend out of phase at the two ends while the midsection 774 remains as a quasi-node point. Vibration energy may not be dissipated as there is no anchor coupled to the midsection 774 of the tapered lever 406. As such, anchor losses may be avoided.

In the following, simulation of a gyroscope device according to various embodiments will be described. The simulation characterizes the resonant performance and Coriolis response of the gyroscope device.

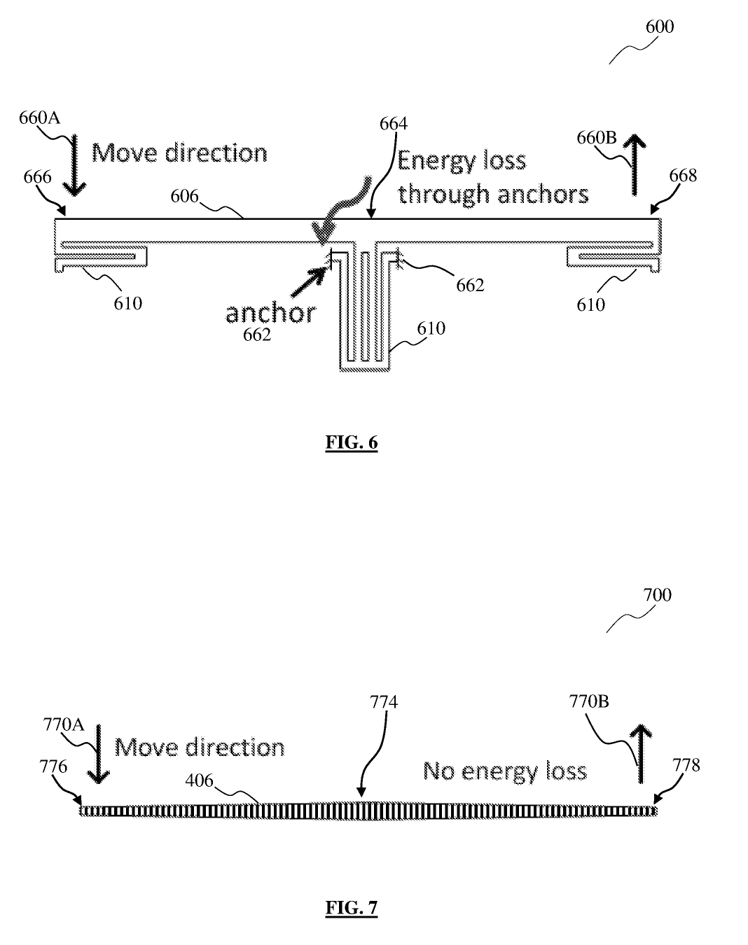

FIG. 8A shows a simulation mode shape diagram 800A of a gyroscope device according to various embodiments, operating in a drive mode. The drive mode may also be referred herein as the excitation mode. The gyroscope device may include four proof masses 802A, 802B, 802C and 802D, each of which may be the proof mass 302. Each proof mass may be excited into vibrating along a drive axis. The drive axis may be 45° relative to the x-axis and the y-axis. The proof masses may be driven to move in anti-phase with one another, by driving electrodes. Two opposed proof masses, in other words, diagonally positioned proof masses may each move towards each other. For example, proof mass 802A and 802D may move towards one another. The proof mass 802A may move in a direction 880A. The proof mass 802D may move in a direction 880D. The directions 880A and 880D may be at least substantially parallel to the first diagonal 442 of the outer frame of the gyroscope device. The other two opposed proof masses may each move away from one another in the orthogonal direction. For example, proof mass 802B and proof mass 802C may move away from each other. The proof mass 802B may move in a direction 880B while the proof mass 802C may move in a direction 880C. The direction 880B and the direction 880C may be at least substantially parallel to the second diagonal 444 of the outer frame of the gyroscope device. The anti-phase drive motions may be synchronized using four tapered levers. The tapered levers may be the tapered levers 406.

FIG. 8B shows a simulation mode shape diagram 800B of a gyroscope device according to various embodiments, operating in a sense mode. When the gyroscope device is rotated about the sensing axis, the proof masses 802A, 802B, 802C and 802D may each experience a linear excitation or a shift in their vibration directions. The sensing axis may be at least substantially perpendicular to the drive axis. The proof masses may be linearly displaced from the motions that they were driven to vibrate in the drive mode. For example, the gyroscope device may be rotated in a clockwise direction 884. When the gyroscope device is rotated clockwise, the proof mass 802A may experience a Coriolis force in a direction 882A, the proof mass 802B may experience a Coriolis force in a direction 882B, the proof mass 802C may experience a Coriolis force in a direction 882C and the proof mass 802D may experience a Coriolis force in a direction 882D. The Coriolis force experienced by each proof mass may be at least substantially perpendicular to the drive direction exerted on the proof mass. The Coriolis force caused by the rotation of the gyroscope device may be sensed or measured by sensing electrodes.

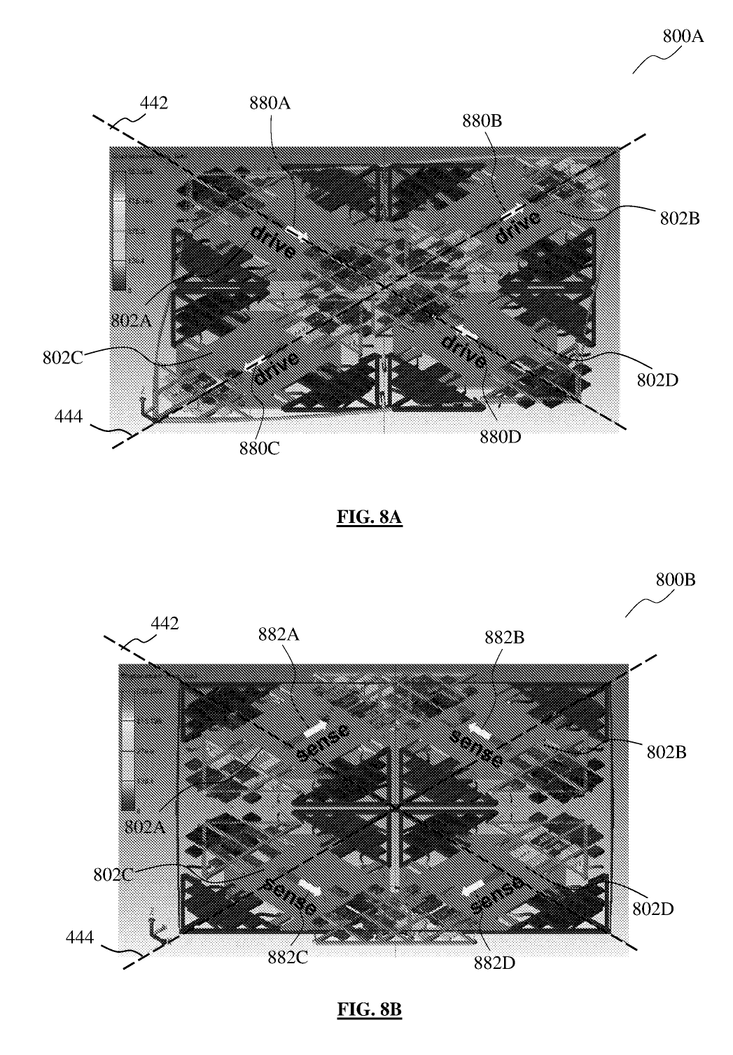

FIGS. 9A to 9F show a method for fabricating a gyroscope device according to various embodiments. The method may include fabricating the gyroscope device on a small semiconductor chip. The gyroscope device may be fabricated based on a silicon-on-insulator (SOI) process, based on a 2-mask process. The structures of the gyroscope device may be fabricated on a device layer. The device layer may be a low resistivity layer and may have a thickness that is in a range from about 10 μm to about 50 μm, for example in a range of about 20 um to about 30 um, for example, about 30 um. The method may be cost-effective and simple to carry out.

FIG. 9A shows a diagram 900A showing a substrate. The substrate may be a SOI wafer including a first silicon layer 990, a second silicon layer 992 and a buried oxide layer 994. The buried oxide layer 994 may include silicon dioxide. The buried oxide layer 994 may be sandwiched between the first silicon layer 990 and the second silicon layer 992. As an example, the first silicon layer 990 may have a thickness that is in a range from about 100 um to about 1000 um, for example about 700 um while the second silicon layer 992 may have a thickness that is in a range from about 10 μm to about 50 μm, for example in a range of about 20 um to about 30 um, for example, about 30 um in thickness. The buried oxide 994 may have a thickness that is in a range from about 1 um to 5 um, for example about 2 um. The second silicon layer 992 may also be referred herein as the device layer.

FIG. 9B shows a diagram 900B showing a process in the method for fabricating a gyroscope device. The process may include depositing a metallic layer 996 on the SOI wafer. The metallic layer 996 may include aluminum. The metallic layer 996 may be about 0.5 um to 1.5 um in thickness. As an example, the metallic layer may be about 0.75 um to 1 um thick. The metallic layer 996 may be sputtered onto the second silicon layer 992.

FIG. 9C shows a diagram 900C showing a process in the method for fabricating a gyroscope device. The process may include patterning the metallic layer 996 to form a patterned metallic layer 996′. The process may define bonding pads on the wafer surface. The patterned metallic layer 996′ may include at least one of bonding pads or electrodes.

In the following processes, the gyroscope structures, also referred herein as device structures, may be etched into the SOI wafer down to the buried oxide layer.

FIG. 9D shows a diagram 900D showing a process in the method for fabricating a gyroscope device. The process may be part of an etching process. In this process, the device structures of the gyroscope are formed. The process may include providing a patterned mask 998, also referred herein as an etch mask layer, over the patterned metallic layer 996′. The patterned mask 998 may be provided by plasma-enhanced chemical vapor deposition (PECVD). The patterned mask 998 may include an oxide, for example, silicon dioxide. The patterned mask 998 may be about 1 um in thickness.

FIG. 9E shows a diagram 900E showing a process in the method for fabricating a gyroscope device. The process may include etching the second silicon layer 992 through the patterned mask 998. All the device structures of the gyroscope device, including the outer frame, the four cells and internal structures of the cells may be patterned using the patterned mask 998. The etching may be performed by carrying out deep reaction ion etching (DRIE). The etching may form a plurality of release holes 912 and a plurality of device structures 910. Each release hole 912 may be positioned between two adjacent device structures 910. The etching may reach a top surface of the buried oxide layer 994. In other words, the plurality of release holes 912 may reach the buried oxide layer 994.

FIG. 9F shows a diagram 900F showing a process in the method for fabricating a gyroscope device. The process may include etching the buried oxide layer 994 through the patterned mask 998 and the release holes 912. The etching process may be isotropic and may include DRIE. Following the etching of the buried oxide layer 994, the patterned mask 998 may be released. The release holes 912 may be used to achieve a proper release time in the release step. The patterned mask 998 may be released by carrying out vapor hydrofluoric etching. The device structures formed in the second silicon layer 992 may be movable structures.

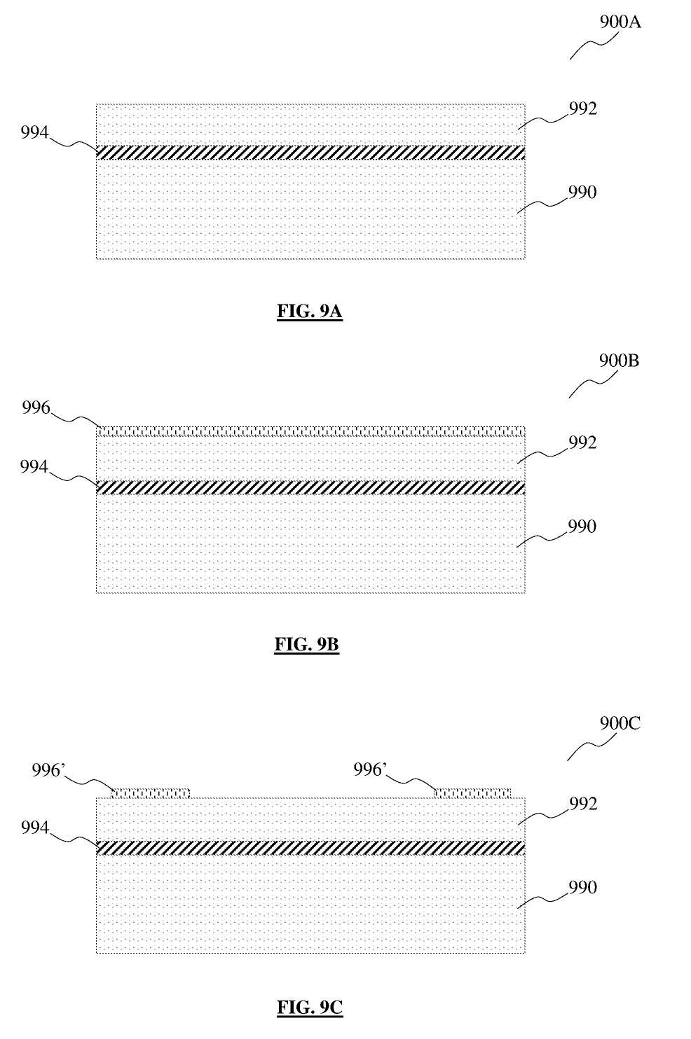

FIG. 10 shows a conceptual diagram of a gyroscope device 1000 according to various embodiments. The gyroscope device 1000 may be similar or identical to the gyroscope device 300. The gyroscope device 1000 may include an outer frame 1020 and four cells 1040. The four cells 1040 may be arranged as an array. Each cell 1040 of the four cells 1040 may include a proof mass 1002 and four electrode frames 1012. The proof mass 1002 may be arranged at least substantially in a centre region of the cell 1040. Each electrode frame 1012 of the four electrode frames 1012 may be arranged at a corner region of the cell 1040 and may be coupled to a respective side of the proof mass 1002. The outer frame 1020, the cells 1040, the proof masses 1002 and the electrode frames 1012 may be coupled with each other, like indicated by lines 1050, for example electrically coupled, for example using a line or a cable, and/ or mechanically coupled.

In other words, the gyroscope device 1000 may include four cells 1040 and an outer frame 1020 surrounding the four cells 1040. The cells 1040 may be similar or identical to the cells 440. The outer frame 1020 may include four tapered levers 406. Each cell 1040 may be a quadrant of the gyroscope device 1000. The four cells 1040 may be arranged as a 2×2 array. The array may include two rows and two columns within the outer frame 1020. There may be two cells 1040 in each row and in each column of the array. Each cell 1040 may include a proof mass 1002 which may be similar or identical to the proof mass 302. The proof mass 1002 may be arranged at least substantially in the middle of the cell 1040. Each cell 1040 may further include four electrode frames 1012. The electrode frames 1012 may be similar or identical to the electrode frames 412. Each corner of the cell 1040 may have an electrode frame 1012 arranged therein. There may be an electrode frame 1012 coupled to each side of the proof mass 1002. The proof mass 1002 may have four sides. One electrode frame of the four electrode frames 1012 of each cell may include a coupling element at a corner of the one electrode frame. The coupling element may be adjoined to the outer frame 1020. The electrode frame that includes a coupling element may be the corner electrode frame 411.

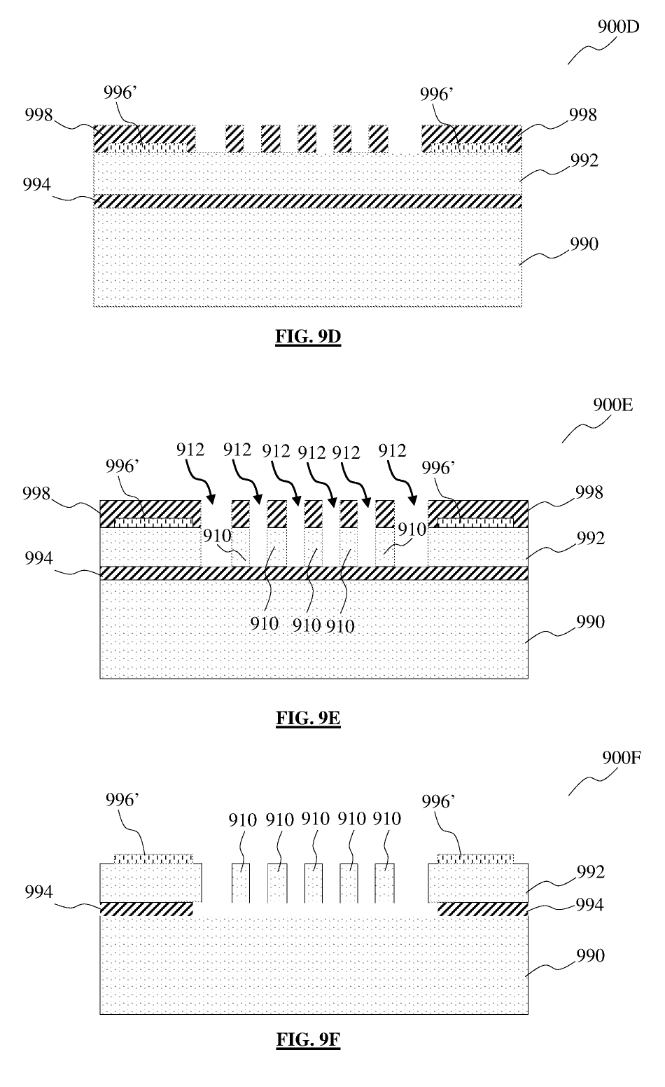

FIG. 11 shows a conceptual diagram of a gyroscope device 1100 according to various embodiments. The gyroscope device 1100 may be similar to the gyroscope device 1000 in that it may also include the outer frame 1020 and the four cells 1040. The gyroscope device 1100 may further include a coupling spring 1004. The coupling spring 1004 may be similar to or identical to the central coupling spring 404. The coupling spring 1004 may be arranged at least substantially in a centre of the outer frame 1020 and may be coupled to each cell 1040. The outer frame 1020, the cells 1040, the proof masses 1002, the electrode frames 1012 and the coupling spring 1004 may be coupled with each other, like indicated by lines 1150, for example electrically coupled, for example using a line or a cable, and/ or mechanically coupled.

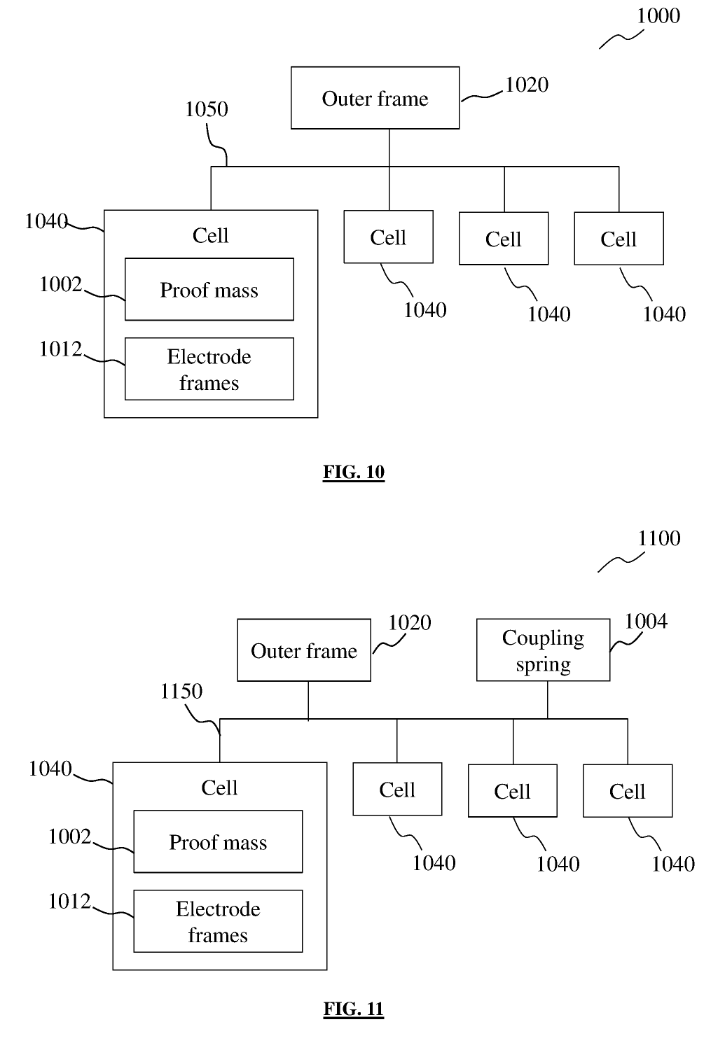

FIG. 12 shows a flow diagram 1200 illustrating a method for fabricating a gyroscope device according to various embodiments. The fabricated gyroscope device may be the gyroscope 300, 1000 or 1100. The method may include a plurality of processes. In 1202, an outer frame may be formed. In 1204, four cells may be provided within the outer frame. Providing each cell within the outer frame may include providing a proof mass arranged at least substantially in a centre region of the cell and forming four electrode frames in the cell. Forming the four electrode frames may include forming electrodes within each electrode frame. The electrodes may be formed by sputtering a metallic layer on a substrate and may further include patterning the metallic layer. Each electrode frame of the four electrode frames may be arranged at a corner region of the cell. Each electrode frame may be coupled to a respective side of the proof mass. The four cells may be arranged as an array. The array may include two rows and two columns. The outer frame or the four cells may be provided by the method shown in the flow diagram 1300.

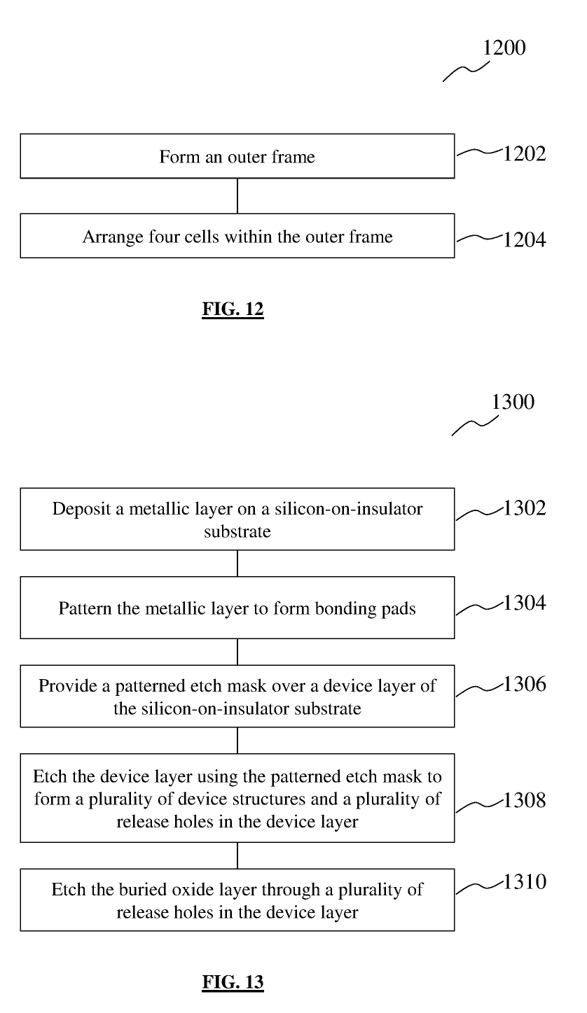

FIG. 13 shows a flow diagram 1300 illustrating a method for fabricating a gyroscope device according to various embodiments. The fabricated gyroscope device may be the gyroscope 300, 1000 or 1100. The method may include a plurality of processes. In 1302, a metallic layer maybe deposited on a silicon-on-insulator (SOI) substrate. The metallic layer may include aluminum. In 1304, the metallic layer may be patterned to form bonding pads. In 1306, a patterned etch mask may be provided over a device layer of the SOI substrate. Providing the patterned etch mask may include depositing an etch mask layer, such as a layer including silicon dioxide, over the SOI substrate and patterning the etch mask layer to form the patterned etch mask. In 1308, the device layer may be etched using the patterned etch mask to form a plurality of device structures and a plurality of release holes in the device layer. The plurality of device structures and the plurality of release holes may reach a buried oxide layer within the SOI substrate. The etching process may include deep reactive ion etching. In 1310, the buried oxide layer may be etched through a plurality of release holes in the device layer, for example, by carrying out vapor hydrofluoric etching. The method may further include removing the etch mask layer. The etch mask layer may be removed by vapor hydrofluoric acid etching.

In the following, various aspects of this disclosure will be illustrated:

Example 1 is a gyroscope device. The gyroscope device may include an outer frame; and four cells arranged within the outer frame, each cell of the four cells including: a proof mass arranged at least substantially in a centre region of the cell; and four electrode frames, each electrode frame of the four electrode frames arranged at a corner region of the cell and coupled to a respective side of the proof mass.

In Example 2, the subject matter of Example 1 can optionally include that the proof mass in a first cell and the proof mass in a cell diagonal to the first cell are configured to move towards one another.

In Example 3, the subject matter of Example 2 can optionally include that the proof masses in the remaining two cells are configured to move away from one another.

In Example 4, the subject matter of any one of Examples 1 to 3 can optionally include a coupling spring arranged at least substantially in a centre region of the outer frame, the coupling spring coupled to each cell.

In Example 5, the subject matter of any one of Examples 1 to 4 can optionally include that each cell is coupled to the outer frame at only one corner of the cell.

In Example 6, the subject matter of any one of Examples 1 to 5 can optionally include that each cell is coupled to adjacent cells by a spring.

In Example 7 the subject matter of any one of Examples 1 to 6 can optionally include that each electrode frame is coupled to the respective side of the proof mass by a plurality of springs.

In Example 8, the subject matter of any one of Examples 1 to 7 can optionally include that the four electrode frames of each cell include a first pair of electrode frames and a second pair of electrode frames.

In Example 9, the subject matter of Example 8 can optionally include that a distance between two electrode frames of the first pair of electrode frames is at least substantially parallel to a first diagonal of the outer frame.

In Example 10, the subject matter of Example 9 can optionally include that a distance between two electrode frames of the second pair of electrode frames is at least substantially parallel to a second diagonal of the outer frame, wherein the second diagonal is at least substantially perpendicular to the first diagonal.

In Example 11, the subject matter of Example 9 or Example 10 can optionally include that the first pair of electrode frames includes driving electrodes configured to drive the proof mass into vibrating along the first diagonal of the outer frame.

In Example 12, the subject matter of any one of Examples 9 to 11 can optionally include that the first pair of electrode frames includes sensing electrodes configured to sense movements of the proof mass along an axis at least substantially parallel to the first diagonal of the outer frame.

In Example 13, the subject matter of Example 10 can optionally include that the second pair of electrode frames includes driving electrodes configured to drive the proof mass into vibrating along the second diagonal of the outer frame.

In Example 14, the subject matter of Example 10 or Example 13 can optionally include that the second pair of electrode frames includes sensing electrodes configured to sense movements of the proof mass along an axis at least substantially parallel to the second diagonal of the outer frame.

In Example 15, the subject matter of any one of Examples 1 to 14 can optionally include that each electrode frame of the four electrode frames is at least substantially triangular.

In Example 16, the subject matter of Example 15 can optionally include that one electrode frame of the four electrode frames of each cell includes a coupling element at a corner of the one electrode frame, the coupling element adjoined to the outer frame.

In Example 17, the subject matter of any one of Examples 1 to 16 can optionally include that each electrode frame includes at least one electrode.

In Example 18, the subject matter of Example 17 can optionally include that the at least one electrode includes a comb electrode.

In Example 19, the subject matter of Example 17 or Example 18 can optionally include that the at least one electrode includes at least one of a driving electrode, a sensing electrode, a frequency tuning electrode or a quadrature-nulling electrode.

In Example 20, the subject matter of any one of Examples 1 to 19 can optionally include that the outer frame is at least substantially square.

In Example 21, the subject matter of any one of Examples 1 to 20 can optionally include that the outer frame includes four levers arranged to form the outer frame.

In Example 22, the subject matter of Example 21 can optionally include that each lever of the four levers is narrower at two ends of the lever than at a midsection of the lever.

In Example 23, the subject matter of Example 21 or Example 22 can optionally include that a midsection of each lever of the fours levers is free to move.

In Example 24, the subject matter of any one of Examples 1 to 23 can optionally include that the proof mass of each cell is at least substantially square.

In Example 25, the subject matter of any one of Examples 1 to 24 can optionally include that the gyroscope device is a micro-electromechanical systems device.

In Example 26, the subject matter of any one of Examples 1 to 25 can optionally include that the four cells are arranged as an array including two rows and two columns

Example 27 is a method for fabricating a gyroscope device. The method may include forming an outer frame; providing four cells within the outer frame, wherein providing each cell of the four cells includes: providing a proof mass arranged at least substantially in a centre region of the cell; forming four electrode frames in the cell, wherein each electrode frame of the four electrode frames is arranged at a corner region of the cell, and wherein each electrode frame is coupled to a respective side of the proof mass.

In Example 28, the subject matter of Example 27 can optionally include that forming the four electrode frames includes forming electrodes within each electrode frame of the four electrode frames.

In Example 29, the subject matter of Example 28 can optionally include that forming the electrodes includes sputtering a metallic layer on a substrate.

In Example 30, the subject matter of Example 29 can optionally include that forming the electrode further includes patterning the metallic layer.

In Example 31, the subject matter of any one of Examples 27 to 30 can optionally include that at least one of forming the outer frame or providing the four cells includes: depositing a metallic layer on a silicon-on-insulator substrate; patterning the metallic layer to form bonding pads; providing a patterned etch mask over a device layer of the silicon-on-insulator substrate; etching the device layer using the patterned etch mask to form a plurality of device structures and a plurality of release holes in the device layer, wherein the plurality of device structures and the plurality of release holes reach a buried oxide layer within the silicon-on-insulator substrate; and etching the buried oxide layer through the plurality of release holes in the device layer.

Example 32 is a method for fabricating a gyroscope device. The method may include: depositing a metallic layer on a silicon-on-insulator substrate; patterning the metallic layer to form bonding pads; providing a patterned etch mask over a device layer of the silicon-on-insulator substrate; etching the device layer using the patterned etch mask to form a plurality of device structures and a plurality of release holes in the device layer, wherein the plurality of device structures and the plurality of release holes reach a buried oxide layer within the silicon-on-insulator substrate; and etching the buried oxide layer through the plurality of release holes in the device layer.

In Example 33, the subject matter of Example 32 can optionally include that providing the patterned etch mask includes depositing an etch mask layer over the silicon-on-insulator substrate and patterning the etch mask layer.

In Example 34, the subject matter of Example 32 or Example 33 can optionally include that the metallic layer includes aluminum.

In Example 35, the subject matter of any one of Examples 32 to 34 can optionally include that etching the silicon-on-insulator substrate includes carrying out deep reactive ion etching.

In Example 36, the subject matter of any one of Examples 32 to 35 can optionally include removing the etch mask layer.

In Example 37, the subject matter of Example 36 can optionally include that removing the etch mask layer includes carrying out vapor hydrofluoric acid etching.

In Example 38, the subject matter of any one of Examples 32 to 37 can optionally include that etching the buried oxide layer includes carrying out vapor hydrofluoric acid etching.

In Example 39, the subject matter of any one of Examples 32 to 38 can optionally include that the etch mask layer includes silicon dioxide.

In Example 40, the subject matter of any one of Examples 32 to 39 can optionally include that the gyroscope device includes: an outer frame; and four cells arranged within the outer frame, each cell of the four cells including: a proof mass arranged at least substantially in a centre region of the cell; and four electrode frames, each electrode frame of the four electrode frames arranged at a corner region of the cell and coupled to a respective side of the proof mass.

While embodiments of the invention have been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced. It will be appreciated that common numerals, used in the relevant drawings, refer to components that serve a similar or the same purpose.

1. A gyroscope device comprising:
an outer frame; and
four cells arranged within the outer frame, each cell of the four cells comprising:
a proof mass arranged at least substantially in a centre region of the cell; and
four electrode frames, each electrode frame of the four electrode frames arranged at a corner region of the cell and coupled to a respective side of the proof mass.

2. The gyroscope device of claim 1, wherein the proof mass in a first cell and the proof mass in a cell diagonal to the first cell are configured to move towards one another.

3. The gyroscope device of claim 2, wherein the proof masses in the remaining two cells are configured to move away from one another.

4. The gyroscope device of claim 1, further comprising:
a coupling spring arranged at least substantially in a centre region of the outer frame, the coupling spring coupled to each cell.

5. The gyroscope device of claim 1, wherein each cell is coupled to the outer frame at only one corner of the cell.

6. The gyroscope device of claim 1, wherein each electrode frame is coupled to the respective side of the proof mass by a plurality of springs.

7. The gyroscope device of claim 1, wherein the four electrode frames of each cell comprise a first pair of electrode frames and a second pair of electrode frames.

8. The gyroscope device of claim 7, wherein a distance between two electrode frames of the first pair of electrode frames is at least substantially parallel to a first diagonal of the outer frame.

9. The gyroscope device of claim 8, wherein a distance between two electrode frames of the second pair of electrode frames is at least substantially parallel to a second diagonal of the outer frame, wherein the second diagonal is at least substantially perpendicular to the first diagonal.

10. The gyroscope device of claim 8, wherein the first pair of electrode frames comprises driving electrodes configured to drive the proof mass into vibrating along the first diagonal of the outer frame.

11. The gyroscope device of claim 9, wherein the second pair of electrode frames comprises sensing electrodes configured to sense movements of the proof mass along an axis at least substantially parallel to the second diagonal of the outer frame.

12. The gyroscope device of claim 1, wherein each electrode frame of the four electrode frames is at least substantially triangular.

13. The gyroscope device of claim 12, wherein one electrode frame of the four electrode frames of each cell comprises a coupling element at a corner of the one electrode frame, the coupling element adjoined to the outer frame.

14. The gyroscope device of claim 1, wherein each electrode frame comprises at least one electrode.

15. The gyroscope device of claim 14, wherein the at least one electrode comprises at least one of a driving electrode, a sensing electrode, a frequency tuning electrode or a quadrature-nulling electrode.

16. The gyroscope device of claim 1, wherein the outer frame comprises four levers arranged to form the outer frame.

17. The gyroscope device of claim 16, wherein each lever of the four levers is narrower at two ends of the lever than at a midsection of the lever.

18. The gyroscope device of claim 16, wherein a midsection of each lever of the fours levers is free to move.

19. A method for fabricating a gyroscope device, the method comprising:
forming an outer frame;
providing four cells within the outer frame,
wherein providing each cell of the four cells comprises:
providing a proof mass arranged at least substantially in a centre region of the cell;
forming four electrode frames in the cell, wherein each electrode frame of the four electrode frames is arranged at a corner region of the cell, and wherein each electrode frame is coupled to a respective side of the proof mass

20. The method of claim 19, wherein at least one of forming the outer frame or providing the four cells comprises:
depositing a metallic layer on a silicon-on-insulator substrate;
patterning the metallic layer to form bonding pads;
providing a patterned etch mask over a device layer of the silicon-on-insulator substrate;
etching the device layer using the patterned etch mask to form a plurality of device structures and a plurality of release holes in the device layer, wherein the plurality of device structures and the plurality of release holes reach a buried oxide layer within the silicon-on-insulator substrate; and
etching the buried oxide layer through the plurality of release holes in the device layer.
